(19) United States
(12) Patent Application Publication
(10) Pub. No.: US 2006/0063422 A1
(43) Pub. Date: Mar. 23, 2006

(54) Electrical card connector with improved detect means

(75) Inventors: Chao Wang Lu, Tu-chen (TW); Gwou-Jong Tseng, Tu-Chun (TW); Senbing Zhao, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/148,127

(22) Filed: Jun. 7, 2005

(30) Foreign Application Priority Data
Sep. 21, 2004 (CN) 2004200798155

(51) Int. Cl. H01R 3/00

(52) U.S. Cl. 439/489

(57) ABSTRACT

An electrical connector (100) provides a housing (1) defining a receiving space (10), a number of contacts (3) received in the housing, and an improved detect means including a first switch contact (4) and a second switch contact (5). The contacts and the switch contacts are embedded in corresponding passageways (111) defined on a mounting wall (11) of the housing. The second switch contact has a body portion (53) and a tail portion (54) curved backwardly from the body portion. The tail portion provides an extension potion (541) extending laterally to be positioned under the first switch contact and be spaced from the first switch contact a distance, and the first switch contact is depressed to engage with the extension portion when an electronic card (7) is inserted into the receiving space of the housing.

### BACKGROUND OF THE INVENTION

1. Field of the Invention

This invention generally relates to a card connector designed for the connection between an electronic apparatus, such as digital cameras, mobile telephones, or the like, and an electronic card, more particularly, to a card connector with a detecting means.

2. Description of the Prior Art

A typical card connector is generally provided with a housing having a card receiving mouth for permitting free insertion or removal of an electronic card, a plurality of contacts arranged in the housing for electrically contacting with pads provided on the electronic card, and a detecting means for detecting the insertion of the electronic card.

U.S. Pat. No. 6,045,049 discloses a card connector includes a housing, a plurality of contacts and a detect apparatus for detecting whether a card is inserted or not. The detect apparatus includes a first switch element and a second switch element. When a card is inserted into the housing, the first switch element is depressed by a lead edge of the card to engage with the second switch element, thereby closing a switch circuit. The switch elements are arranged in two levels of the housing in the direction of the thickness of the housing, which indeed increases the thickness of the housing as well as the entire card connector. Furthermore, the first and second switch element should be fixed into corresponding slots during manufacturing, and it is difficult to stamp out the switch elements and the contacts by a common stamping mold, which are both inefficient and do not benefit to coplanarity of solder tails of the switch elements and the contacts.

Hence, an improved detect means of a card connector is desired to overcome the above problems.

### BRIEF SUMMARY OF THE INVENTION

It is an object of the present invention to provide a card connector which has a detect means that makes the connector more compact and more efficient in manufacturing.

In order to attain the objective above, an electrical connector according to the present invention provides a housing adapted for receiving an electronic card, a plurality of contacts configured to electrically contact with the electricall pads of the electronic card, and a detect means for detecting whether the electronic card is inserted or not. The housing defines a receiving space and a plurality of passageways extending parallel in the direction of insertion of the electronic card. The plurality of contacts are received in corresponding passageways and partially exposed to the receiving space. The detect means comprises a first switch contact and a second switch contact. The first switch contact and the second switch contact are disposed in outmost two passageways. The first switch contact comprises a first body portion and a biased portion extending inclinedly and upwardly from the first body portion. The second switch contact comprises a second body portion and a tail portion curved backwardly and extending from the second body portion. The tail portion comprises an extension portion. The extension portion extends laterally to be positioned under the biased portion of the first switch contact and spaced from the biased portion a distance. When the electronic card is inserted into a proper depth of the receiving space, the biased portion is depressed to engage with the extension portion.

The second switch contact has a backwardly-curved tail portion, so the two switch contacts have a different length. Furthermore, They are arranged parallel with each other and the contacts. Hence, the switch contacts and contacts are able to be obtained through a stamping process by only a common stamping mold on a common sheet metal and then, molded integrally with the housing together. In this manner, the present invention provides a more compact card connector and is more efficient in manufacturing than the prior arts do.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of a card connector according to the present invention and an electronic card to be loaded into the card connector;

FIG. 2 is another perspective view of the card connector from a bottom view;

FIG. 3 is a partially assembled view of the card connector with the top cover taken aside for clarity;

FIG. 4 is an exploded view of the card connector from another perspective view;

FIG. 5 is a perspective view of the a plurality of contacts and a detect means;

FIG. 6 is a perspective view of the card connector with the electronic card being inserted thereinto;

FIG. 7 is a section view taken along line 7-7 of FIG. 1; and

FIG. 8 is a section view taken along line 8-8 of FIG. 6.

### DETAILED DESCRIPTION OF THE INVENTION

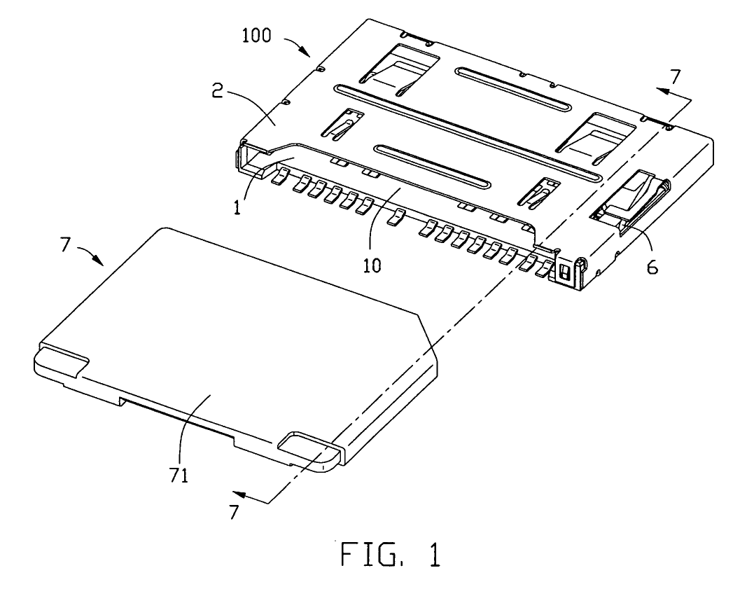

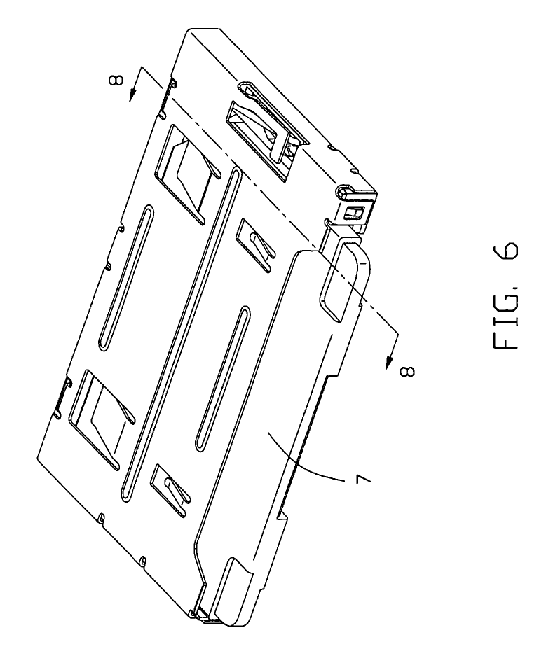

The embodiments of the present invention will now be described with the reference to FIGS. 1 through 8.

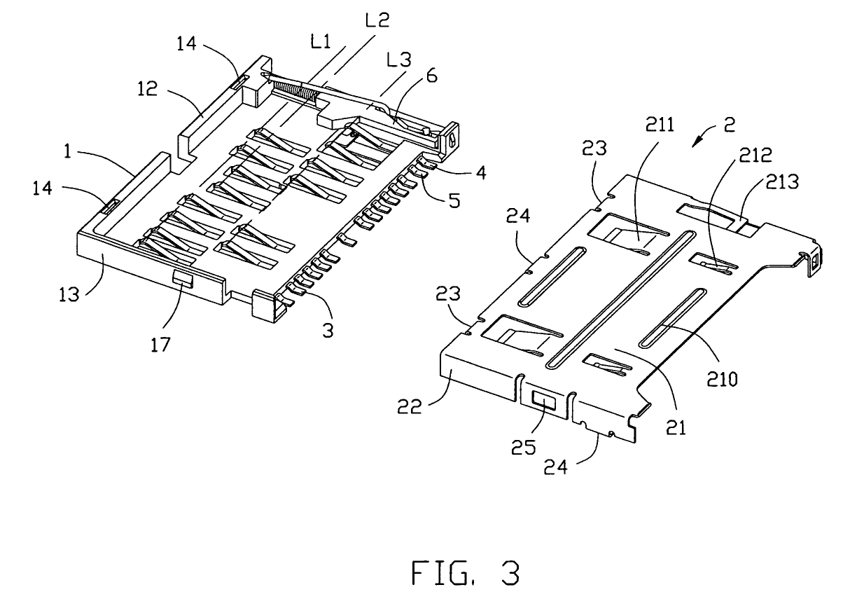

As illustrated in FIG. 3, an electrical connector 100 according to the present invention, which is applicable to electronic devices including a printed circuit board (not shown), or the like, on which the card connector 100 is mounted, comprises a housing 1 made of insulating material, a top cover 2 mounted on the housing 1, a plurality of contacts 3 for electrically contact with corresponding external contacts on an electronic card 7, a detect means consisting of a first switch contacts 4 and a second switch contact 5 to detect the insertion of the card 7, and an eject mechanism 6.

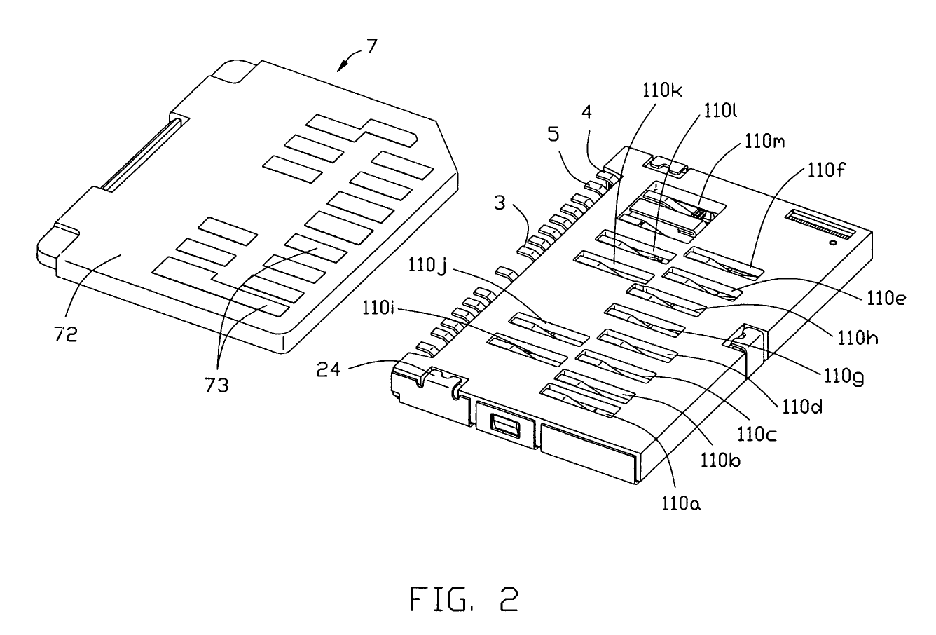

The electronic card 7, such as MMC(Multi-Media Card), as shown in FIGS. 1 and 2, is to be loaded into the card connector 100 and provides with a plurality of electrical pads 73. These electrical pads 73 serving as external contacts for a memory element in the electronic card 7, are arranged in a single row or plural rows on one surface 72 of the electronic card 7. When the electronic card 7 is loaded in the card connector 100, the pads 73 will mechanically connect with corresponding contacts 3 so that data contained in the memory element is able to be provided to the given device and data from the device is able to be recorded to the memory element of the electronic card 7.

Referring to FIGS. 1 through 4, the insulative housing 1 comprises a substantially rectangular bottom wall 11, a side wall 13 and an end wall 12 interconnecting with the side wall 13. The ejector 6 is arranged on the opposite end of the bottom wall 11 away from the side wall 13. A receiving space 10 with an opening to receive the electronic card 7, is fored by the walls 11, 12, 13, the ejector 6 and the top cover 2.

A number of passageways 111 are substantially arranged on a common plane/level of the bottom wall 11, each of which communicates with one or more slots 110 which arranged in three rows on the bottom wall 11. These slots 110 allow for resilient flexing of corresponding portions of contacts 3 and switch contacts 4, 5. As shown in FIG. 2, the slots 110, with substantially same length in the direction of insertion (and withdrawal) of the electronic card 7, are arranged in three rows, comprising a number of back slots 110a˜110f closest to the end wall 12, middle slots 110g˜110h, and front slots 110i˜110m closest to the opening of receiving space 10. The front slots 110m, different from other slots 110a˜110l in width, communicates with three passageways 111 while other slots 110a˜110l communicate with only one respective passageway 111.

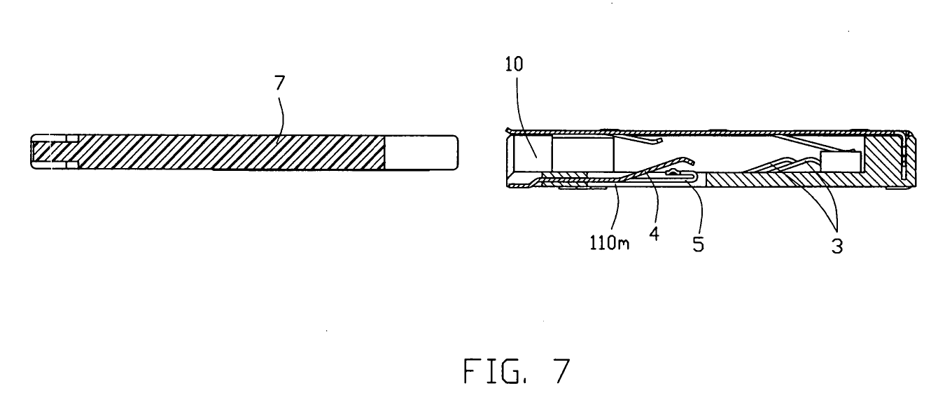

Referring to FIGS. 1 through 3, the top cover 2 is formed from a sheet metal by applying the punching and pressing processes, and comprises a ceiling 21, and side walls 22 extending downwardly from the ceiling 21. A number of ribs 210 is provided on the ceiling 21 to strengthen the top cover 2, and a blank 25 is provided on the side wall 22 for fastening on the housing 1. In addition, the ceiling 21 provides major springs 211 to increase card retention force when the electronic card 7 is inserted, and minor springs 212 to increase retention force when the electronic card 7 is ejected. Furthermore, the top cover 2 also provides flat tails 24 for soldering to the printed circuit board of the given device, and right-angle bends 23 with barbs for fastening on the housing. In assembly, as shown in FIGS. 2 and 7, the top cover 2 is mounted on the housing 2 to form the receiving space 10, with a projection 17 on the housing 1 fastening with the blank 25 and the right-angle bends 23 inserted into corresponding notches 14 on the end wall 12 and fastened therein.

Referring to FIG. 3, a plurality of contacts and detect means 4, 5 are implanted in the bottom wall 11 of the housing 1 and substantially parallel to one another. When the electronic card 7 is loaded in the receiving space 10, the electrical pads 73 are brought into contact (under pressure) with corresponding contacts 3.

Referring to FIGS. 3 through 5, each contact 3, a resilient piece, extends in the housing along the direction of the insertion of the electronic card 7, and provides a biased portion 33 on free end thereof such that the contact 3 is able to be deflect in the direction of thickness of the housing 1. A contact portion 34 is provided on distal end of the biased portion 33 and is brought into contact with a corresponding electrical pad 73 when the electronic card 7 is inserted. In addition, the contacts 3 each provides on their base end portion a terminal portion 31. The terminal portions 31 extend through the front surface of the bottom wall 11 and project outwardly so as to be able to mechanically and electrically connect with the printed circuit board. An implanted portion 32, communicating with the biased portion 33 and the terminal portion 31, is embedded in a corresponding passageway 111.

The contacts 3, due to different length of implanted portion 32, are divided into a plurality of long contacts 3a comparatively longest, short contacts 3c comparatively shortest and middle contacts 3b. In assembly, the contact portion 34 of long contacts 3a are disposed upon corresponding back slots 110a˜110f, while contact portions 34 of short contacts 3c and the middle contacts 3b are disposed upon corresponding the front slots 110i˜110l and middle slots 110g˜110h, respectively. As result, the contact portions 34 are arranged in different rows L1, L2, L3, which accords with the electrical pads 73. The contact portions 34 of middle contacts 3b contact with corresponding electrical pads 73 in the first place. In this way, the electronic card 7 is connected to the given device to be read through electrical pads 73, contacts 3 and the printed circuit board.

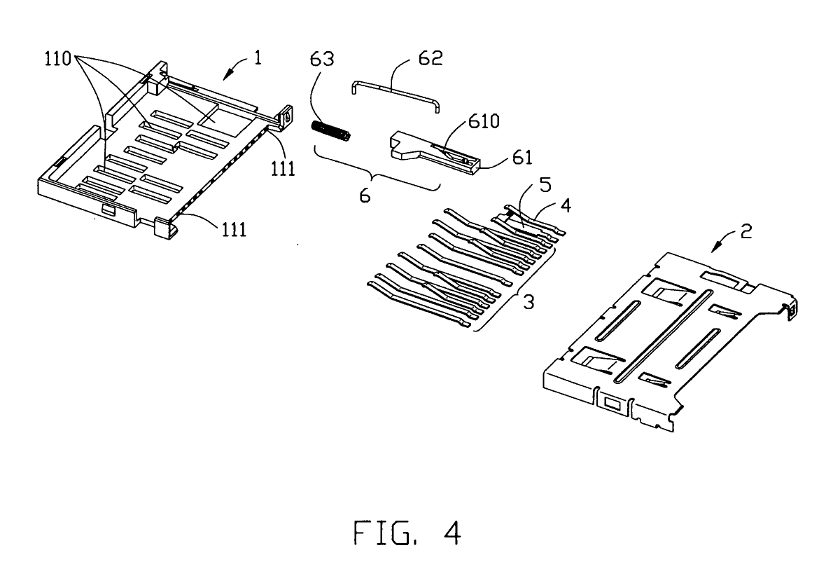

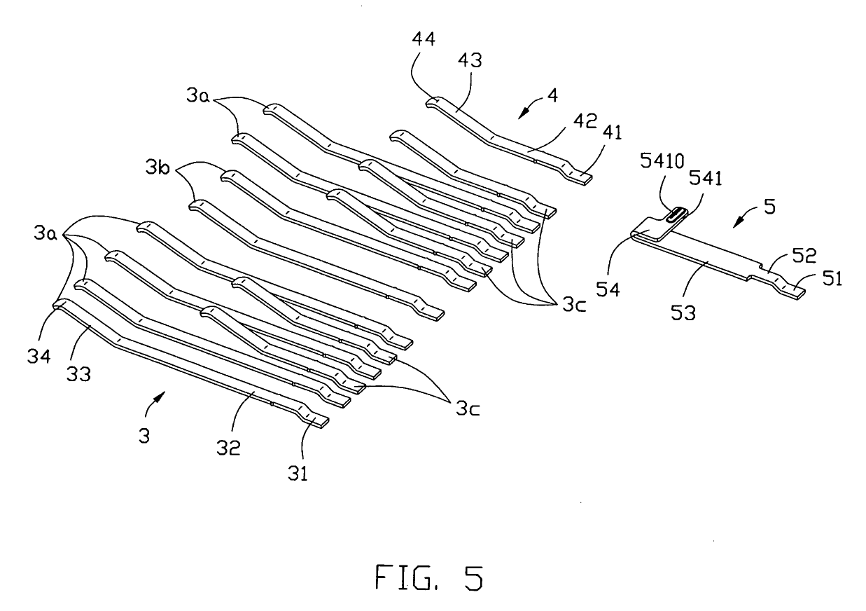

Referring to FIG. 5 in conjunction with FIGS. 3 and 4, the detect means includes the first switch contact 4 and the second switch contact 5. The first switch contact 4 and the second switch contact 5 are embedded in the bottom wall 11 and parallel to the contacts 3. The switch contacts 4, 5 have solder tails 41, 51 for surface connection as by soldering, to appropriate switch circuit trace on the printed circuit board.

The first switch contact 4, with a similar structure to the short contacts 3c, has a biased portion 43 provided on distal end thereof with a contact portion 44, and an implanted portion 42 interconnecting the biased portion 43 and the solder tail 41, commonly arranged in a longitudinal direction. In this embodiment, the contact portion 44 will not electrically connect with any electrical pad 73. In assembly, the first switch contact 4 is received in the housing 1, with its implanted portion 42 embedded in the outermost passageway 111 that communicating with the front slot 110m and its biased portion 43 extending into the receiving space 10 so as to be deflected at the front end portion of the electronic card 7 in the direction of thickness of the housing 1.

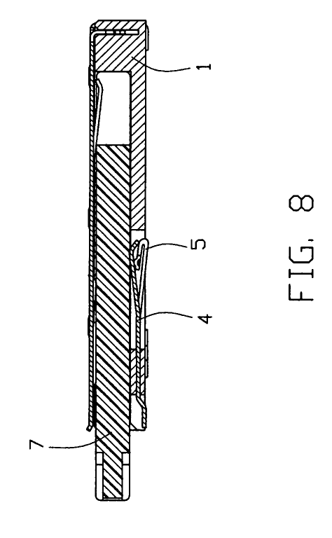

The second switch contact 5 includes a longitudinal main body 53, a solder tail 51 extending from the main body 53 for surface mounting on the printed circuit board, and a raised portion 54 curved backwardly and extending from the main body 53. The raised portion 54 provides on its distal end with an extension piece 541 that extends laterally to be opposite the first switch contact 4 at a distance. In addition, the extension portion 541 has a projection portion 5410, as shown in FIGS. 7 and 8, for obtaining a better engagement between the first switch contact 4 and the second switch contact 5 when the biased portion 43 is depressed by the insertion of the electronic card 7. In this embodiment, the main body 53 has greater width in the direction orthogonal to the direction of the card insertion, which prevents the second switch contact 5 from frictionally engaging the printed circuit board when the electronic card 7 is inserted, otherwise, it may damage the printed circuit board, and even short circuit occurs.

In assembly, as shown in FIG. 3, the first switch contact 4 and the second switch contact 5 are positioned in neighbored passageways 111, and solder tails 41, 51 are coplanar with each other and terminal portions 31 of contacts 3. The raised portion 54, except the projection portion 5410, as shown in FIGS. 7 and 8, remains in the slot 110m of the bottom wall 11. The projection portion 5410 projects into the receiving space 10 and is positioned at a distance under the biased portion 43 of the first switch contact 4, namely the first and second switch contact 4, 5 are separated before the electronic card 7 is inserted. When the electronic card 7 is inserted into the card connector 100, the leading edge of the card 7 engages the biased portion 43 and biased offset the contact portion 44 downwardly in the direction of the thickness of the card 7 for engaging the second switch contact 5. Engagement of the switch contacts 4, 5 closes the switch circuit on the printed circuit board to activate the card connector. It means that data contained in the card 7 is able to be provided to the given device and/or data from the device is able to be recorded to the card 7.

The adjacent switch contact 4, 5 are different in length and the extension portion 541 does not overlap over any portion of the first switch contact 4 on a sheet metal. Furthermore, the terminal portions 31 and solder tails 41, 51 are coplanar and extend in a common direction. Hence, the two switch contact 4, 5 along with all of the contacts 3 are able to be stamped out from the common sheet metal by a common stamping mold at a time. After the stamping process, a contact strip consisting of the contacts 3 and switch contacts 4, 5 and a carrier (not shown) which communicates with the terminal portions 31 and solder tails 41, 51, is molded integrally with housing 1 during a insert-molding process. In this manner, the contacts 3 and switch contacts 4, 5 are parallel arranged on a common plane of the bottom wall 11 of the housing 1, which not only reduces height of the card connector 100, but also is easy in manufacturing and reduces cost especially in mass production. Apart from that, excellent coplanarity of terminal portions 31 and solder tails 41, 51 is obtained, for the contacts 3 and switch contacts 4, 5 are stamped out and insert-molded together.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A card connector for receiving an electronic card having electrical pads, comprising:
a housing defining a receiving space and comprising a mounting wall, the mounting wall defining a plurality of passageways extending parallel in the direction of insertion of the electronic card;
a plurality of contacts configured to electrically contact with the electricall pads of the electronic card, received in corresponding passageways, and partially exposed to the receiving space; and
a detect means comprising a first switch contact and a second switch contact, the first switch contact and the second switch contact being disposed in outmost two passageways, the first switch contact comprising a first body portion and a biased portion extending inclinedly and upwardly from the first body portion, the second switch contact comprising a second body portion and a tail portion curved backwardly and extending from the second body portion, wherein
the tail portion comprises an extension portion, and the extension portion extends laterally to be positioned under the biased portion of the first switch contact and spaced from the biased portion a distance, and the biased portion is depressed to engage with the extension portion when the electronic card is inserted into the receiving space of the housing.

2. The card connector according to claim 1, wherein the first switch contact and the second switch contact are stamped out of a common sheet metal, and join with a common carrier before they are molded integrally with the housing.

3. The card connector according to claim 1, wherein the extension portion defines a projection portion toward the first switch contact.

4. The card connector according to claim 1, wherein the tail portion of the second switch contact has a main body extending parallel to the second body portion.

5. The card connector according to claim 4, wherein the second body portion is wider than the first body portion.

6. The card connector according to claim 1, wherein the plurality of contacts, the first switch contact and the second switch contact each comprises a solder portion, and wherein the solder portions extend beyond the housing and are placed on a common plane.

7. The card connector according to claim 6, wherein the mounting wall defines a plurality of slots, and wherein one of the slots communicates with at least two passageways.

8. The card connector according to claim 7, wherein the second body portion are at least partially disposed in said one slot.

9. A card connector for use with an electronic card, comprising:
an insulative housing;
a plurality of signal contacts disposed in the housing along a front-to-back direction;
said housing further equipped with a first contact switch including a first longitudinal portion extending along said front-to-back direction with a first contact portion at a distal end thereof, and a second contact switch located beside said first contact and including a second longitudinal portion extending along said front-to-back direction with a raised portion backwardly extending from a distal end of the second longitudinal portion; wherein
said raised portion further includes an extension portion extending laterally toward first contact switch with a second contact portion essentially located in vertical alignment with the said first contact portion for engagement with the first contact portion when at least one of said first longitudinal portion and said second longitudinal portion is deflected by the electronic card.

10. The connector as claimed in claim 9, wherein said first longitudinal portion is deflected.

11. The connector as claimed in claim 9, wherein said second contact portion is aligned with the first contact portion along said front-to-back direction when said raised portion is in an extended manner before backward bending.

12. The connector as claimed in claim 11, wherein said first contact switch and said second contact switch are stamped from a same carrier strip before insert molded into the housing.

13. The connector as claimed in claim 10, wherein the second contact portion is essentially located vertically between the first contact portion and the second longitudinal portion.

14. A card connector for use with an electronic card, comprising:
an insulative housing;
a plurality of signal contacts disposed in the housing along a front-to-back direction;
said housing further equipped with a first contact switch including a first longitudinal portion extending along said front-to-back direction with a first contact portion at a distal end thereof, and a second contact switch located beside said first contact essentially in a parallel relation and including a second longitudinal portion extending along said front-to-back direction; wherein
an end portion located at a front end of the said longitudinal portion and including an extension portion extending laterally toward first contact switch with a second contact portion essentially located in vertical alignment with the said first contact portion for engagement with the first contact portion when at least one of said first longitudinal portion and said second longitudinal portion is deflected by the electronic card.

15. The connector as claimed in claim 14, wherein said second contact portion is aligned with the first contact portion along said front-to-back direction when said end portion is in an extended manner before some portion of the second contact switch is bent to intentionally move the second contact portion to a final position where the second contact portion is vertically aligned with the first contact portion.

16. The connector as claimed in claim 15, wherein said first contact switch and said second contact switch are stamped from a same carrier strip before insert molded into the housing.

17. The connector as claimed in claim 14, wherein said first longitudinal portion is deflected.

18. The connector as claimed in claim 17, wherein said second contact portion is essentially located vertically between the first contact portion and the second longitudinal portion.
